(19) United States
(12) Patent Application Publication
(10) Pub. No.: US 2025/0244549 A1
(43) Pub. Date: Jul. 31, 2025

(54) CABLE SUPPORT DEVICES

(71) Applicant: Preformed Line Products Company, Mayfield, OH (US)

(72) Inventors: Nicholas Lees, Lakewood, OH (US); Jacob Palmer, Chesterland, OH (US); John Lee Jones, Independence, OH (US); Douglas Bell, Solon, OH (US); Ben Ciesielczyk, Madison, OH (US)

(21) Appl. No.: 18/428,309

(22) Filed: Jan. 31, 2024

(51) Int. Cl. G02B 6/44

(52) U.S. Cl. CPC G02B 6/4439

(57) ABSTRACT

Disclosed herein are support devices for a plurality of cables that include a body that extends a length along a central longitudinal axis between a first end and a second end and that defines an outer surface. A slit is formed in the body that extends the length of the body between the first end and the second end. A plurality of inner ports are formed in the body that extend the length of the body between the first end and the second end, and each of the plurality of inner ports is adapted to receive one of the plurality of cables. An inner passageway is formed in the body that is connected to the slit, interconnects the plurality of inner ports, and extends the length of the body between the first end and the second end.

### BACKGROUND

Power lines, transmission lines, and other cables, such as fiber optic cables, are commonly suspended from and/or between support structures, such as poles or towers. These cables experience static stresses because the cables are suspended at longitudinally distanced points. These cables also experience dynamic stresses caused by cable oscillation, often due to wind, ice, and temperature variations. Due to the fragile optical fibers they contain, fiber optic cables particularly require careful handling by the devices that support them to minimize the risk of damage due to these static and dynamic stresses.

Moreover, as fiber optic cable systems, such as all-dielectric self-supporting (ADSS) systems, have gained in popularity and continued to expand, there is a need to handle multiple cables within a single cable support device. Such support devices should adequately control the static and dynamic stresses experienced by each of the multiple cables that are housed within the support device. However, existing cable support devices designed for handling multiple cables often have numerous and/or unrestrained parts that can add cost and make assembly and installation difficult.

Accordingly, a need exists for improved cable support devices that safely manage multiple cables in a cost-effective and simplified manner.

### SUMMARY

In one embodiment, a support device for a plurality of cables includes a body that extends a length along a central longitudinal axis between a first end and a second end and that defines an outer surface; a slit formed in the body that extends the length of the body between the first end and the second end; a plurality of inner ports formed in the body that extend the length of the body between the first end and the second end, each of the plurality of inner ports adapted to receive one of the plurality of cables; and an inner passageway formed in the body that is connected to the slit, interconnects the plurality of inner ports, and extends the length of the body between the first end and the second end; wherein the slit, the plurality of inner ports, and the inner passageway segment the body into a first sidewall portion, a second sidewall portion connected to the first sidewall portion, and a core portion disposed between the first sidewall portion and the second sidewall portion; and wherein the support device is secured within an associated housing that exerts a compressive force over the support device.

In another embodiment, a support device for a plurality of cables includes an annular sleeve body that extends a length along a central longitudinal axis between a first sleeve end and a second sleeve end and that defines an outer sleeve surface, an inner sleeve surface, and an interior; a slit formed in the annular sleeve body that extends the length of the annular sleeve body between the first sleeve end and the second sleeve end; and a retainer body that extends a length along a central longitudinal axis between a first retainer end and a second retainer end and that defines an outer retainer surface, wherein the retainer body fits within the interior of the annular sleeve body and further includes: a plurality of channels formed in the retainer body that extend the length of the retainer body between the first retainer end and the second retainer end; and a plurality of inner ports formed in the retainer body that extend the length of the retainer body between the first retainer end and the second retainer end, wherein each one of the plurality of inner ports is connected to one of the plurality of channels and is adapted to receive one of the plurality of cables; wherein the support device is secured within an associated housing that exerts a compressive force over the support device.

In yet another embodiment, a support device for a plurality of cables includes a body that extends a length along a central longitudinal axis between a first end and a second end and that defines an outer surface; and a plurality of outer ports formed in the body that extend the length of the body between the first end and the second end, each of the plurality of outer ports adapted to receive one of the plurality of cables; wherein the support device is secured within an associated housing that exerts a compressive force over the support device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a perspective view of a cable support device that supports a plurality of cables, according to one or more embodiments shown and described herein;

FIG. 1B schematically depicts a side view of the cable support device of FIG. 1A, according to one or more embodiments shown and described herein;

FIG. 2A schematically depicts a perspective view of another cable support device that supports a plurality of cables, according to one or more embodiments shown and described herein;

FIG. 2B schematically depicts a side view of the cable support device of FIG. 2A, according to one or more embodiments shown and described herein;

FIG. 3A schematically depicts a perspective view of the cable support device of FIG. 1A secured within an associated housing, according to one or more embodiments shown and described herein;

FIG. 3B schematically depicts a side view of the associated housing and cable support device of FIG. 3A, according to one or more embodiments shown and described herein;

FIG. 4A schematically depicts a perspective view of an annular sleeve body that is one piece of a two-piece cable support device, according to one or more embodiments shown and described herein;

FIG. 4B schematically depicts a perspective view of a retainer body that fits within the annular sleeve body of FIG. 4A, according to one or more embodiments shown and described herein;

FIG. 5 schematically depicts a side view of the annular sleeve body of FIG. 4A and the retainer body of FIG. 4B being secured within an associated housing, according to one or more embodiments shown and described herein;

FIG. 6 schematically depicts a perspective view of another cable support device that supports a plurality of cables, according to one or more embodiments shown and described herein; and

FIG. 7 schematically depicts a side view of the cable support device of FIG. 6 being secured within an associated housing, according to one or more embodiments shown and described herein.

### DETAILED DESCRIPTION

Embodiments described herein are directed to cable support devices that include a body formed with features that allow multiple cables, such as fiber optic cables, to be received and contained within the body. Various embodiments of the cable support devices and the operation thereof are described in more detail herein. Whenever possible, the same reference numerals will be used throughout the drawings to refer to the same or like parts.

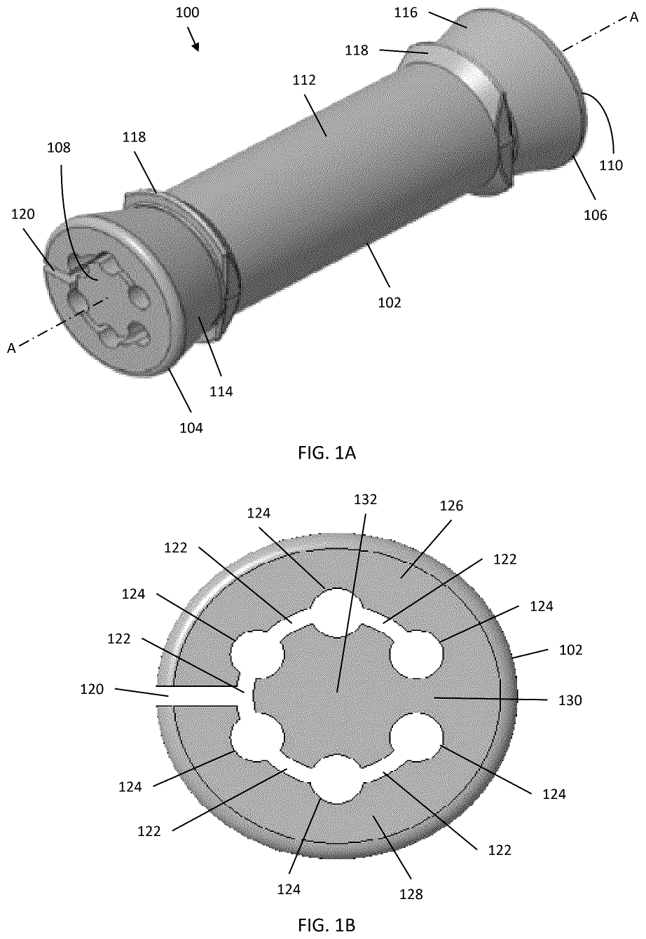

Referring now to FIGS. 1A and 1B, a device for supporting a plurality of cables is illustrated according to one or more embodiments of the present disclosure. The cable support device 100 generally includes a body 102 that extends a length along a central longitudinal axis A-A between a first end 104 and a second end 106. The body 102 may be substantially cylindrical in shape, however other shapes are contemplated and possible. The first end 104 and the second end 106 of the body 102 terminate at a first end face 108 and a second end face 110, respectively. Both the first end face 108 and second end face 110 generally extend along a plane that is perpendicular to the central longitudinal axis A-A of the body 102. The body 102 further defines an outer surface 112. In some embodiments, the body 102 of the cable support device 100 is made of an elastomeric material, such as, for example, neoprene, thermoplastic polyurethane (TPU), urethane, or silicon. However, other materials are contemplated and possible.

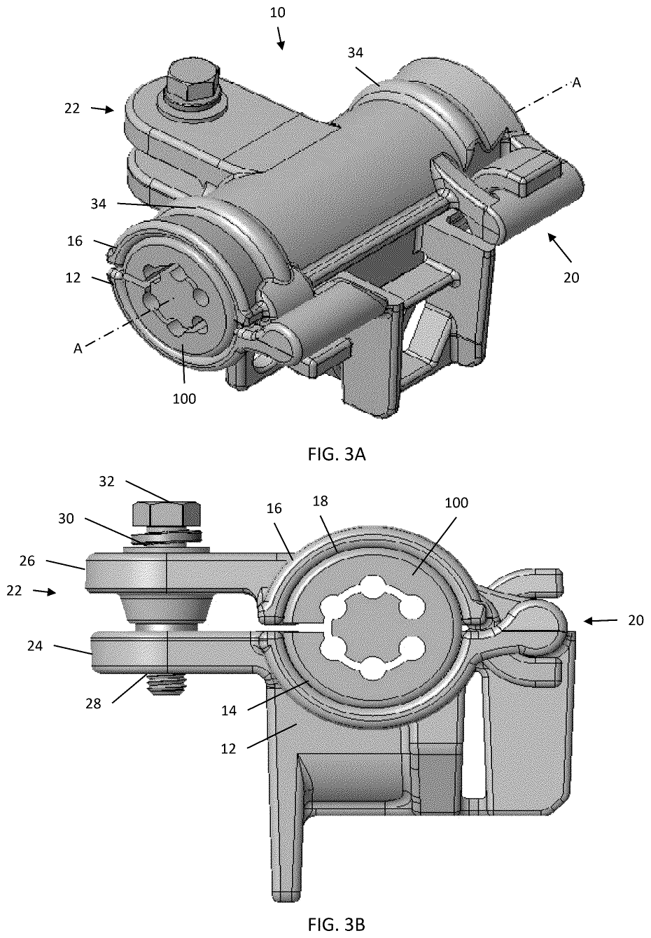

The body 102 of the cable support device 100 is generally sized and adapted to fit within a portion of an associated housing (e.g., housing 10 illustrated in FIGS. 3A-3B). As described in further detail below, the associated housing is adapted to exert a compressive force over the outer surface 112 of the body 102 to help retain the body 102 within the associated housing. In some embodiments, to further help securely retain the body 102 within the associated housing, the body 102 may be formed with one or more retention features adapted to engage one or more corresponding retention features formed in the associated housing. For example, the body 102 may include a first frustoconical portion 114 formed at the first end 104 of the body 102 and a second frustoconical portion 116 formed at the second end 106 of the body 102. The first frustoconical portion 114 and the second frustoconical portion 116 help prevent the body 102 from slipping out of the associated housing in the direction of the central longitudinal axis A-A. As another example, the body 102 may include one or more ridges 118 formed in the outer surface 112. The one or more ridges 118 are received within one or more corresponding mating grooves formed in the portion of the associated housing where the body 102 is securely retained to help prevent the body 102 from slipping out of the associated housing in the direction of the central longitudinal axis A-A.

The cable support device 100 provides support for the plurality of cables via various features formed in the body 102. In accordance with some embodiments, these features of the body 102 generally include a slit 120, an inner passageway 122, and a plurality of inner ports 124. Each of the slit 120, the inner passageway 122, and the plurality of inner ports 124 may be formed, for example, during a molding or extrusion process of the body 102 of the support device 100.

The slit 120, the inner passageway 122, and the plurality of inner ports 124 each extend the length of the body 102 between the first end 104 and the second end 106. The slit 120 may be cut into the outer surface 112 of the body 102 and extend a distance into the body 102 toward the central longitudinal axis A-A. The slit 120 connects to the inner passageway 122 and acts as a channel that provides access to the inner passageway 122. The inner passageway 122 interconnects the plurality of inner ports 124. In this regard, the inner passageway 122 may also be described as a plurality of inner passageways 122 where each of the plurality of inner passageways 122 interconnects two adjacent inner ports of the plurality of inner ports 124. Moreover, when described as a plurality of inner passageways 122, one of the inner passageways is connected to the slit 120.

A width of the inner passageway 122 is generally less than a width or diameter of each of the plurality of inner ports 124. In some embodiments, the inner passageway 122 and the plurality of inner ports 124 extend radially around the central longitudinal axis A-A and may define a generally C-shaped pattern. However, other patterns are contemplated and possible. In addition, in some embodiments, each of the plurality of inner ports 124 are equally spaced apart from each other. However, it is contemplated and possible for the spacing between each of the plurality of inner ports 124 to be varied.

As described in further detail below, each of the plurality of inner ports 124 is adapted to receive one of the plurality of cables. In this regard, while the plurality of inner ports 124 are illustrated in FIGS. 1A and 1B as being generally circular in profile to accommodate circular cables, the plurality of inner ports 124 may be sized and shaped to accommodate cables of different sizes and shapes. For example, the plurality of inner ports 124 may be rectangular or pill-shaped to accommodate flat cables. Moreover, while FIGS. 1A and 1B illustrate six inner ports making up the plurality of inner ports 124, it is contemplated and possible that more or less inner ports can be included in the plurality of inner ports 124.

In addition, the slit 120, the inner passageway 122, and the plurality of inner ports 124 segment the body 102 into various portions. In accordance with some embodiments, these various portions of the body 102 generally include a first sidewall portion 126, a second sidewall portion 128 connected to the first sidewall portion 126, and a core portion 132 disposed between the first sidewall portion 126 and the second sidewall portion 128. In some embodiments, the core portion 132 is solid. The point where the first sidewall portion 126 connects to the second sidewall portion 128 may be referred to as a flexible hinge portion 130. The flexible hinge portion 130 is generally located on a side of the body 102 which is opposite to the slit 120. Moreover, the core portion 132 connects to the flexible hinge portion 130 such that the core portion 132 is disposed between the first sidewall portion 126 and the second sidewall portion 128.

The flexible hinge portion 130 is defined by a reduced material section formed between the two adjacent inner ports of the plurality of inner ports 124 that are located at the ends of the inner passageway 122. In this regard, the inner passageway 122 does not interconnect the two adjacent inner ports of the plurality of inner ports 124 that are located at the ends of the inner passageway 122. Accordingly, when the inner passageway 122 is described as a plurality of inner passageways 122, the number of inner passageways making up the plurality of inner passageways 122 is one less than the number of inner ports making up the plurality of inner ports 124. For example, FIGS. 1A and 1B illustrate six inner ports making up the plurality of inner ports 124 and five inner passageways making up the plurality of inner passageways 122.

To place the plurality of cables in the cable support device 100, a first one of the cables in the plurality is initially urged through the slit 120 from outside the body 102. The flexible hinge portion 130 permits the first sidewall portion 126 and the second sidewall portion 128 to open away from each other, thereby enlarging the slit 120 such that the cable can be urged through the slit 120 until the cable reaches the inner passageway 122. The cable is then urged through the inner passageway 122 and between the first sidewall portion 126 or the second sidewall portion 128 and the core portion 132. The flexible hinge portion 130 allows the core portion 132 and the first sidewall portion 126 or second sidewall portion 128 to flex away from each other, thereby enlarging the inner passageway 122 such that the cable can be urged through the inner passageway 122 until the cable reaches the desired inner port of the plurality of inner ports 124. Once the cable is received and contained in the desired inner port of the plurality of inner ports 124, a subsequent one of the cables in the plurality can be urged through the slit 120 and the inner passageway 122 as previously described until the subsequent cable is received and contained within another inner port of the plurality of inner ports 124. This process is repeated until each of the plurality of cables is received and contained within a corresponding inner port of the plurality of inner ports 124.

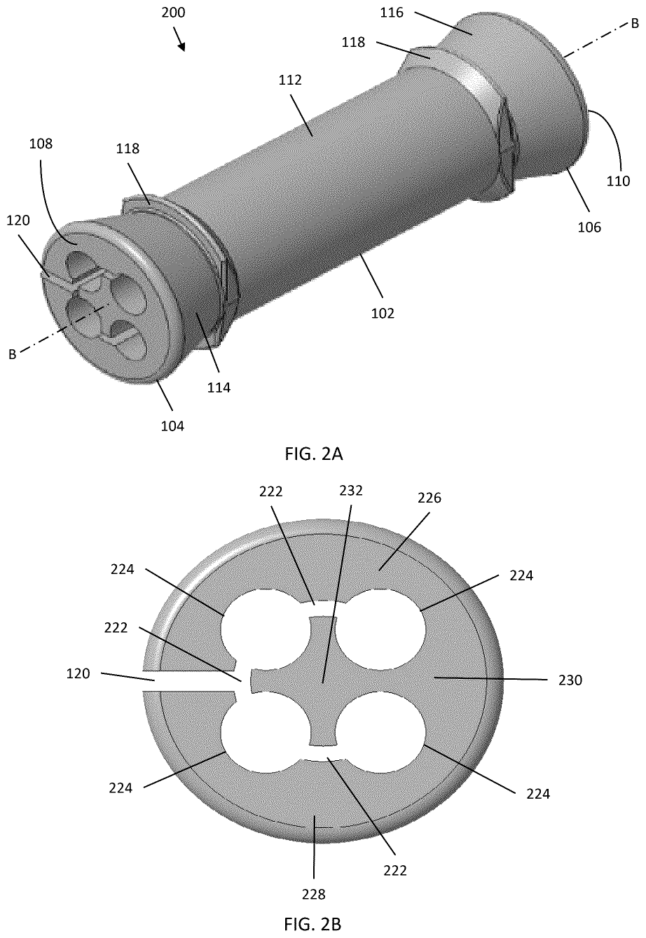

Referring now to FIGS. 2A and 2B, a device for supporting a plurality of cables is illustrated according to one or more embodiments of the present disclosure. The cable support device 200 is generally configured in a similar manner to the cable support device 100 illustrated in FIGS. 1A and 1B. Thus, the cable support device 200 includes a body 102 that extends a length along a central longitudinal axis B-B between a first end 104 and a second end 106 and that defines an outer surface 112. The first end 104 and the second end 106 include a first end face 108 and a second end face 110, respectively. A first frustoconical portion 114 and a second frustoconical portion 116 may be formed at the first end 104 and the second end 106, respectively. In addition, one or more ridges 118 may be formed in the outer surface 112 of the body 102. The body 102 also includes a slit 120 that extends the length of the body 102 between the first end 104 and the second end 106.

One difference between the cable support device 100 and the cable support device 200 is that the cable support device 200 is configured to support a plurality of cables having a larger width or diameter than the width or diameter of the plurality of cables which can be supported in the support device 100. More particularly, each of the plurality of inner ports 224 of the cable support device 200 have a width or diameter which is larger than the width or diameter of each of the plurality of inner ports 124 of the cable support device 100 to accommodate the larger cables. As a result, fewer inner ports make up the plurality of inner ports 224 (e.g., four inner ports) of the cable support device 200 compared to the plurality of inner ports 124 (e.g., six inner ports) of the cable support device 100. In addition, the inner passageway 222 of the cable support device 200 extends radially around the central longitudinal axis B-B a distance that is shorter than the distance which the inner passageway 122 of the cable support device 100 extends radially around the central longitudinal axis A-A. Moreover, when the inner passageway 222 is described as a plurality of inner passageways 222 that interconnect the plurality of inner ports 224, only three inner passageways make up the plurality of inner passageways 222.

Another difference between the cable support device 100 and the cable support device 200 is that the greater width or diameter of each inner port of the plurality of inner ports 224 may result in a thinner flexible hinge portion 230 compared to the flexible hinge portion 130 of the cable support device 100. The thinner flexible hinge portion 230 permits the first sidewall portion 226 and the second sidewall portion 228 to open farther away from each other, thus resulting in a larger slit 120 to accommodate the increased size of the plurality of cables. Similarly, the thinner flexible hinge portion 230 permits the core portion 232 and the first sidewall portion 226 or second sidewall portion 228 to flex a greater distance away from each other to accommodate the increased size of the plurality of cables within the inner passageway 222.

Referring now to FIGS. 3A and 3B, the cable support device 100 is illustrated as being secured within a portion of an associated housing 10 in accordance with embodiments of the present disclosure. While FIGS. 3A and 3B show cable support device 100 secured within the housing 10, it should be understood that the cable support device 200 could similarly be secured within the housing 10. Moreover, while not shown in FIGS. 3A and 3B, it should be understood that a plurality of cables are first placed within the cable support device 100 in the manner described above, prior to the cable support device 100 being secured within the housing 10.

The housing 10 is generally adapted for mounting to associated support structures, such as poles, towers, etc., and the like, such that a plurality of cables can be supported in an aerial span between associated support structures by the housing 10 and the cable support device 100 secured within the housing 10. The housing 10 generally includes a base 12, a cap 16, a hinge structure 20 connecting the base 12 and the cap 16, and a closure mechanism 22 adapted to tighten the cap 16 against the base 12 such that the cable support device 100 is secured between the base 12 and cap 16. The base 12 includes an elongated base groove 14 and the cap 16 includes an elongated cap groove 18. The elongated base groove 14 defines a seat in which the cable support device 100 can initially be received after placement of the plurality of cables within the plurality of inner ports 124. The elongated cap groove 18 pivots about the hinge structure 20 and can be rotated toward the elongated base groove 14 to at least partially cover the portion of the cable support device 100 which is not disposed within the elongated base groove 14. When the elongated cap groove 18 is closed against the elongated base groove 14, a chamber is formed in which the cable support device 100 is retained.

To securely retain the cable support device 100 within the chamber formed by the elongated base groove 14 and elongated cap groove 18, and to securely retain the plurality of cables within the plurality of inner ports 124, the closure mechanism 22 is tightened to exert a compressive force against the cable support device 100. The closure mechanism 22 may generally include a base flange 24 that extends outward from the base 12, a cap flange 26 that extends outward from the cap 16, a threaded aperture 28 formed in the base flange 24, a threaded aperture 30 formed in the cap flange 26, and a bolt 32 that engages each threaded aperture 28 and 30. To tighten the closure mechanism 22, the bolt 32 is rotated within the threaded apertures 28 and 30, thereby drawing the cap 16 and base 12 closer together. As the cap 16 and base 12 draw closer together, the elongated base groove 14 and the elongated cap groove 18 clamp the cable support device 100 therebetween and exert a compressive force over the cable support device 100. This compressive force further causes the first and second sidewall portions 126 and 128 to flex inward toward the core portion 132 via the flexible hinge portion 130. As a result, the plurality of cables are securely retained within the plurality of inner ports 124 due to the compressive force which acts on the plurality of cables between the first and second sidewall portions 126 and 128 and the core portion 132.

To further aid in retaining the plurality of cables within the cable support device 100, the cable support device 100 may be formed with one or more retention features (e.g., first and second frustoconical portions 114, 116 and/or one or more ridges 118) adapted to engage one or more corresponding retention features formed in the housing 10 as discussed above. For example, in some embodiments, the ends of the elongated base groove 14 and the elongated cap groove 18 may each be formed with a frustoconical edge to match the first and second frustoconical portions 114, 116 of the cable support device 100. In other embodiments, the elongated base groove 14 and the elongated cap groove 18 may each be formed with one or more mating grooves 34 which receive the one or more ridges 118 of the cable support device 100.

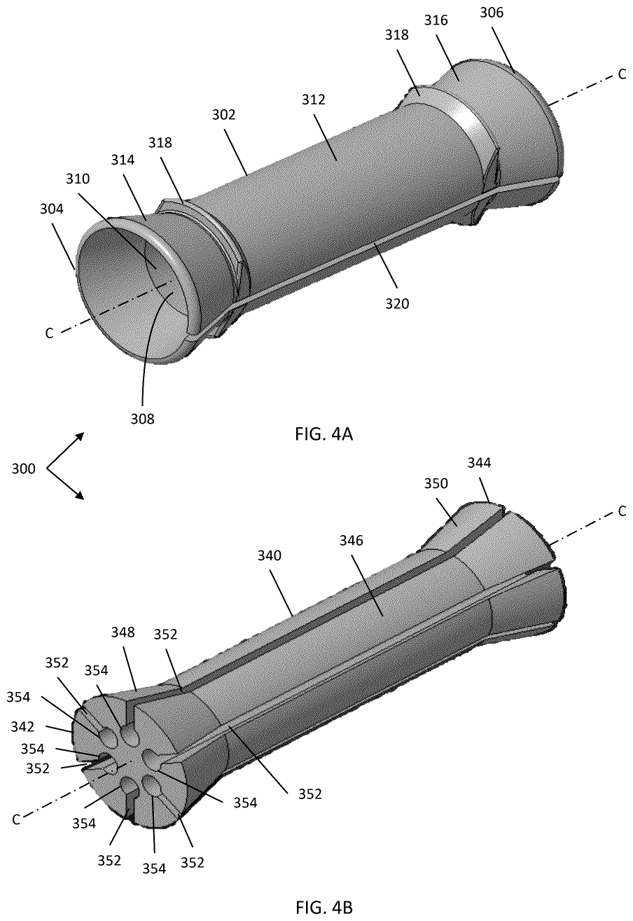

Referring now to FIGS. 4A and 4B, a device for supporting a plurality of cables is illustrated according to one or more embodiments of the present disclosure. The cable support device 300 is configured as a 2-piece device which generally includes annular sleeve body 302 and a retainer body 340 over which the annular sleeve body 302 fits. The annular sleeve body 302 may be substantially tubular in shape and the retainer body 340 may be substantially cylindrical in shape, however other shapes are contemplated and possible. The retainer body 340 is generally adapted to receive and contain the plurality of cables as described in further detail below. The annular sleeve body 302 extends a length along a central longitudinal axis C-C between a first sleeve end 304 and a second sleeve end 306. Moreover, the annular sleeve body 302 defines an outer sleeve surface 312, an inner sleeve surface 310, and an interior 308.

A slit 320 is formed in the annular sleeve body 302 that extends the length of the annular sleeve body 302 between the first sleeve end 304 and the second sleeve end 306. The slit 320 permits the annular sleeve body 302 to flex open such that the retainer body 340 can be inserted into the interior 308 of the annular sleeve body 302. The slit 320 may be formed, for example, during a molding or extrusion process of the annular sleeve body 302 of the support device 300. Alternatively, the slit 320 may be formed by cutting an annular sleeve body formed by molding or extrusion. In some embodiments, the annular sleeve body 302 of the cable support device 300 is made of an elastomeric material, such as, for example, neoprene, thermoplastic polyurethane (TPU), urethane, or silicon. However, other materials are contemplated and possible.

The annular sleeve body 302 (together with the retainer body 340 inserted therein) is generally sized and adapted to fit within a portion of an associated housing (e.g., housing 10 illustrated in FIG. 5). As described in further detail below, the associated housing is adapted to exert a compressive force over the outer surface 312 of the annular sleeve body 302 to help retain the retainer body 340 within the annular sleeve body 302 and to help retain both the annular sleeve body 302 and retainer body 340 inserted therein within the associated housing. In some embodiments, to further help securely retain the annular sleeve body 302 within the associated housing, the annular sleeve body 302 may be formed with one or more retention features adapted to engage one or more corresponding retention features formed in the associated housing. For example, the annular sleeve body 302 may include a first sleeve frustoconical portion 314 formed at the first end 304 of the annular sleeve body 302 and a second sleeve frustoconical portion 316 formed at the second end 306 of the annular sleeve body 302. The first sleeve frustoconical portion 314 and the second sleeve frustoconical portion 316 help prevent the annular sleeve body 302 from slipping out of the associated housing in the direction of the central longitudinal axis C-C. As another example, the annular sleeve body 302 may include one or more ridges 318 formed in the outer surface 312. The one or more ridges 318 are received within one or more corresponding mating grooves formed in the portion of the associated housing where the annular sleeve body 302 is securely retained to help prevent the annular sleeve body 302 from slipping out of the associated housing in the direction of the central longitudinal axis C-C.

The retainer body 340 extends a length along the same central longitudinal axis C-C as the annular sleeve body 302 when the retainer body 340 is inserted into the annular sleeve body 302. The length of the retainer body 340 is defined between a first retainer end 342 and a second retainer end 344. The first retainer end 342 is disposed adjacent the first sleeve end 304 and the second retainer end 344 is disposed adjacent the second sleeve end 306 when the retainer body 340 is inserted into the annular sleeve body 302. In addition, the retainer body 340 defines an outer retainer surface 346 which is substantially covered by the inner sleeve surface 310 when the retainer body 340 is inserted into the annular sleeve body 302. In some embodiments, the retainer body 340 of the cable support device 300 is made of an elastomeric material, such as, for example, neoprene, thermoplastic polyurethane (TPU), urethane, or silicon. However, other materials are contemplated and possible. In some embodiments, the annular sleeve body 302 and the retainer body 340 may be made from the same material. In other embodiments, the annular sleeve body 302 and the retainer body 340 may be made from different materials.

The retainer body 340 is generally sized and adapted to fit within the interior 308 of the annular sleeve body 302. In some embodiments, to help retain the retainer body 340 within the annular sleeve body 302, the retainer body 340 may include a first retainer frustoconical portion 348 formed at the first retainer end 342 and a second retainer frustoconical portion 350 formed at the second retainer end 344. In this regard, the first retainer frustoconical portion 348 engages the first sleeve frustoconical portion 314 and the second retainer frustoconical portion 350 engages the second sleeve frustoconical portion 316 to help secure the retainer body 340 within the annular sleeve body 302. That is, the engagement of the first retainer frustoconical portion 348 with the first sleeve frustoconical portion 314 and the second retainer frustoconical portion 350 with the second sleeve frustoconical portion 316 helps prevent the retainer body 340 from slipping out of the annular sleeve body 302 in the direction of the central longitudinal axis C-C.

A plurality of channels 352 are formed in the retainer body 340 that extend the length of the retainer body 340 between the first retainer end 342 and the second retainer end 344. The plurality of channels 352 are connected to or otherwise provide access to a plurality of inner ports 354 formed in the retainer body 340 that extend the length of the retainer body 340 between the first retainer end 342 and the second retainer end 344. That is, each one of the plurality of inner ports 354 is connected to one of the plurality of channels 352. Moreover, each one of the plurality of inner ports 354 is adapted to receive and/or contain one of the plurality of cables. Each of the plurality of channels 352 have a width that is generally less than a width or diameter of each of the plurality of inner ports 354. In some embodiments, the plurality of channels 352 and the plurality of inner ports 354 radially surround the central longitudinal axis C-C of the retainer body 340 and may define a generally circular shaped pattern. However, other patterns are contemplated and possible. In addition, in some embodiments, each of the plurality of inner ports 354 are equally spaced apart from each other. However, it is contemplated and possible for the spacing between each of the plurality of inner ports 354 to be varied. Each of the plurality of channels 352 and the plurality of inner ports 354 may be formed, for example, during a molding or extrusion process of the retainer body 340 of the support device 300.

As described in further detail below, each of the plurality of inner ports 354 is adapted to receive one of the plurality of cables. In this regard, while the plurality of inner ports 354 are illustrated in FIGS. 4A and 4B as being generally circular in profile to accommodate circular cables, the plurality of inner ports 354 may be sized and shaped to accommodate cables of different sizes and shapes. For example, the plurality of inner ports 354 may be rectangular or pill-shaped to accommodate flat cables. Moreover, while FIGS. 4A and 4B illustrate six inner ports making up the plurality of inner ports 354, it is contemplated and possible that more or less inner ports can be included in the plurality of inner ports 354.

To place the plurality cables in the cable support device 300, a first one of the cables in the plurality is urged through one of the plurality of channels 352 from outside the retainer body 340 until the cable reaches a corresponding one of the plurality of inner ports 354. Once the cable is received and contained in the corresponding one of the plurality of inner ports 354, a subsequent one of the cables in the plurality is placed in a different channel and corresponding port in the same manner. This process is repeated until each of the plurality of cables is received and contained within a corresponding inner port of the plurality of inner ports 354. The annular sleeve body 302 can then be fit over the retainer body 340.

With reference to FIG. 5, as mentioned above, the annular sleeve body 302 (together with the retainer body 340 inserted therein) is generally sized and adapted to fit within a portion of the associated housing 10. The housing 10 illustrated in FIG. 5 is identical to the housing 10 illustrated in FIGS. 3A and 3B. Moreover, while not shown in FIG. 5, it should be understood that a plurality of cables are first placed within the retainer body 340 of the cable support device 300 in the manner described above, prior to the cable support device 300 being secured within the housing 10.

To secure the cable support device 300 within the housing 10, the same procedure as described above with respect to cable support device 100 and the housing 10 is performed. That is, the closure mechanism 22 is tightened by rotating the bolt 32 within the threaded apertures 28 and 30, thereby drawing the cap and base 12 closer together. As the cap 16 and base 12 draw closer together, the elongated base groove 14 and the elongated cap groove 18 clamp the cable support device 300 (including the annular sleeve body 302 and the retainer body 340) therebetween and exert a compressive force over the annular sleeve body 302. This compressive force causes the annular sleeve body 302 to compress against the retainer body 340. As a result, the plurality of cables are securely retained within the plurality of inner ports 354 and are further prevented from dislodging out of the plurality of channels 352 due to the presence of the annular sleeve body 302.

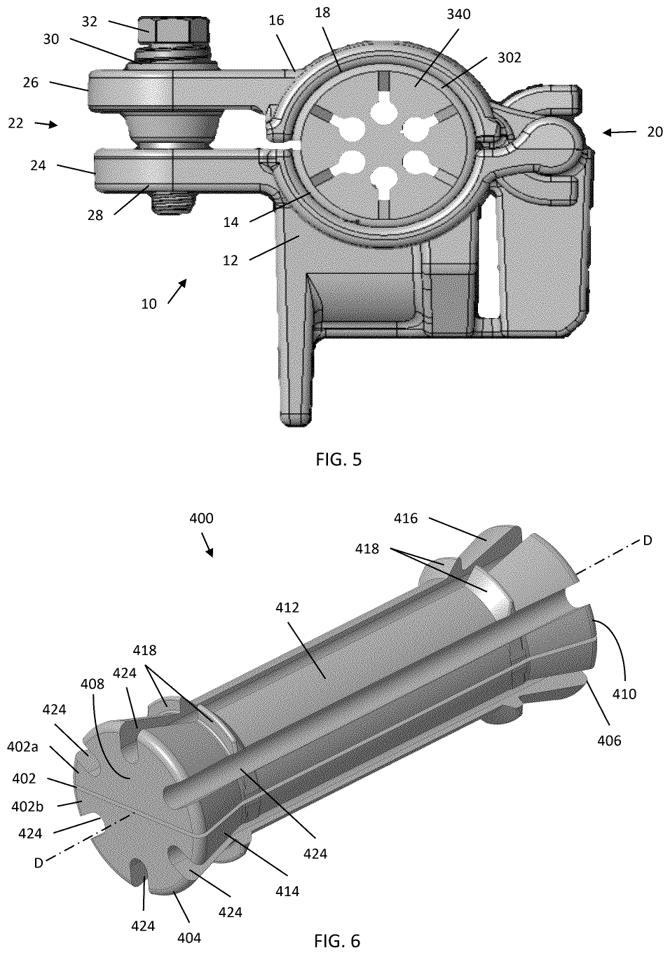

Referring now to FIG. 6, a device for supporting a plurality of cables is illustrated according to one or more embodiments of the present disclosure. The cable support device 400 is generally configured in a similar manner to the cable support device 100 illustrated in FIGS. 1A and 1B, with some key differences. In accordance with some embodiments, the cable support device 400 includes a body 402 that is split between a first body halve 402a and a second body halve 402b, where both the first body halve 402a and the second body halve 402b have substantially similar or the same geometries. However, it is contemplated and possible that the body 402 be split into two or more body portions having the same or different geometries. Moreover, in accordance with some embodiments, the body 402 may be provided as a single solid body. The body 402 of cable support device 400 extends a length along a central longitudinal axis D-D between a first end 404 and a second end 406 and defines an outer surface 412. The first end 404 and the second end 406 include a first end face 408 and a second end face 410, respectively. A first frustoconical portion 414 and a second frustoconical portion 416 may be formed at the first end 404 and the second end 406, respectively. In addition, one or more ridges 418 may be formed in and protrude outward from the outer surface 412 of the body 402.

Another difference of cable support device 400 is that instead of a plurality of inner ports connected by an inner passageway, the body 402 of cable support device 400 provides support for the plurality of cables by a plurality of outer ports 424 formed in the outer surface 412. The plurality of outer ports 424 each extend the length of the body 402 between the first end 404 and the second end 406. In some embodiments, the plurality of outer ports 424 are disposed radially around the central longitudinal axis D-D on the outer surface 412 of the body 402 to form a circular pattern. Moreover, in some embodiments, the plurality of outer ports 424 are U-shaped. However, other shapes are contemplated and possible. In addition, in some embodiments, the plurality of outer ports 424 are equally spaced apart from each other. However, it is contemplated and possible for the spacing between each of the plurality of outer ports 424 to be varied.

Each of the plurality of outer ports 424 is adapted to receive one of the plurality of cables. In this regard, while the plurality of outer ports 424 are illustrated in FIG. 6 as each having a generally circular bottom profile to accommodate circular cables, the plurality of outer ports 424 may be sized and shaped to accommodate cables of different sizes and shapes. For example, the bottom profile of the plurality of outer ports 424 may be rectangular or pill-shaped to accommodate flat cables. Moreover, while FIG. 6 illustrates six outer ports making up the plurality of outer ports 424, it is contemplated and possible that more or less outer ports can be included in the plurality of outer ports 424.

To place the plurality of cables in the cable support device 400, a width or diameter of each outer port in the plurality of outer ports 424 may be less than a width or diameter of each cable in the plurality of cables. In this regard, an interference fit can be achieved between each outer port in the plurality of outer ports 424 and each cable in the plurality of cables to initially retain each cable within each outer port.

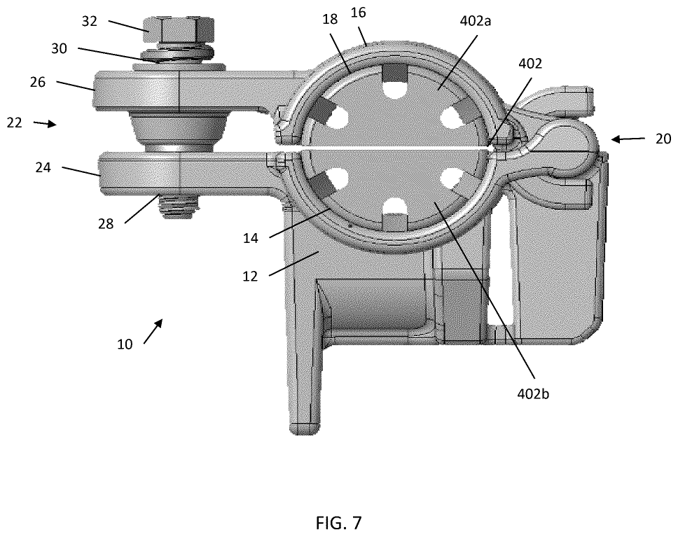

With reference to FIG. 7, the cable support device 400 is shown as being secured within the associated housing 10.

When the body 402 is inserted into the housing with the plurality of cables being received within the plurality of outer ports 424, to secure the cable support device 400 within the housing 10, the same procedure as described above with respect to cable support device 100 and the housing 10 is performed. Thus, as the cap 16 and base 12 draw closer together upon tightening the closure mechanism 22, the elongated base groove 14 and the elongated cap groove 18 clamp the cable support device 400 therebetween and exert a compressive force over the body 402. The compression of the elongated base groove 14 and the elongated cap groove 18 against the plurality of outer ports 424 securely retains the plurality of cables within the plurality of inner ports 424.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A support device for a plurality of cables, comprising:
a body that extends a length along a central longitudinal axis between a first end and a second end and that defines an outer surface;
a slit formed in the body that extends the length of the body between the first end and the second end;
a plurality of inner ports formed in the body that extend the length of the body between the first end and the second end, each of the plurality of inner ports adapted to receive one of the plurality of cables; and
an inner passageway formed in the body that is connected to the slit, interconnects the plurality of inner ports, and extends the length of the body between the first end and the second end;
wherein the slit, the plurality of inner ports, and the inner passageway segment the body into a first sidewall portion, a second sidewall portion connected to the first sidewall portion, and a core portion disposed between the first sidewall portion and the second sidewall portion; and
wherein the support device is secured within an associated housing that exerts a compressive force over the support device.

2. The support device of claim 1, wherein the plurality of inner ports and the inner passageway extend radially around the central longitudinal axis.

3. The support device of claim 1, wherein a width of the inner passageway is less than a diameter of each of the plurality of inner ports.

4. The support device of claim 1, wherein the body is made of an elastomeric material.

5. The support device of claim 1, further comprising a flexible hinge portion that connects the first sidewall portion and the second sidewall portion of the body.

6. The support device of claim 5, wherein the flexible hinge portion is located opposite to the slit.

7. The support device of claim 1, wherein each of the plurality of inner ports are equally spaced apart from each other.

8. The support device of claim 1, wherein the core portion is solid.

9. The support device of claim 1, further comprising a first frustoconical portion formed at the first end of the body and a second frustoconical portion formed at the second end of the body, wherein the first frustoconical portion and the second frustoconical portion are adapted to help secure the body within the associated housing.

10. The support device of claim 1, further comprising one or more ridges formed in the outer surface of the body, wherein the one or more ridges are adapted to help secure the body within the associated housing.

11. A support device for a plurality of cables, comprising:
an annular sleeve body that extends a length along a central longitudinal axis between a first sleeve end and a second sleeve end and that defines an outer sleeve surface, an inner sleeve surface, and an interior;
a slit formed in the annular sleeve body that extends the length of the annular sleeve body between the first sleeve end and the second sleeve end; and
a retainer body that extends a length along a central longitudinal axis between a first retainer end and a second retainer end and that defines an outer retainer surface, wherein the retainer body fits within the interior of the annular sleeve body and further comprises:
a plurality of channels formed in the retainer body that extend the length of the retainer body between the first retainer end and the second retainer end; and
a plurality of inner ports formed in the retainer body that extend the length of the retainer body between the first retainer end and the second retainer end, wherein each one of the plurality of inner ports is connected to one of the plurality of channels and is adapted to receive one of the plurality of cables;
wherein the support device is secured within an associated housing that exerts a compressive force over the support device.

12. The support device of claim 11, wherein the plurality of channels and the plurality of inner ports radially surround the central longitudinal axis of the retainer body.

13. The support device of claim 11, wherein a width of each one of the plurality of channels is less than a diameter of each of the plurality of inner ports.

14. The support device of claim 11, wherein each of the plurality of inner ports are equally spaced apart from each other.

15. The support device of claim 11, wherein the annular sleeve body and the retainer body are made from the same material or from different materials.

16. The support device of claim 11, further comprising:
a first sleeve frustoconical portion formed at the first sleeve end of the annular sleeve body;
a second sleeve frustoconical portion formed at the second sleeve end of the annular sleeve body;
a first retainer frustoconical portion formed at the first retainer end of the retainer body that fits within the first sleeve frustoconical portion; and
a second retainer frustoconical portion formed at the second retainer end of the retainer body that fits within the second sleeve frustoconical portion,
wherein the first retainer frustoconical portion engages the first sleeve frustoconical portion and the second retainer frustoconical portion engages the second sleeve frustoconical portion to help secure the retainer body within the annular sleeve body.

17. The support device of claim 11, further comprising one or more ridges formed in the outer sleeve surface of the annular sleeve body, wherein the one or more ridges are adapted to help secure the annular sleeve body within the associated housing.

18. A support device for a plurality of cables, comprising:
a body that extends a length along a central longitudinal axis between a first end and a second end and that defines an outer surface; and
a plurality of outer ports formed in the outer surface of the body that extend the length of the body between the first end and the second end, each of the plurality of outer ports adapted to receive one of the plurality of cables;
wherein the support device is secured within an associated housing that exerts a compressive force over the support device.

19. The support device of claim 18, wherein the body is split between a first body halve and a second body halve, wherein the first body halve and the second body halve have substantially similar geometries.

20. The support device of claim 18, wherein a width of each of the plurality of outer ports is less than a diameter of each of the plurality of cables.
